(19) United States
(12) Patent Application Publication
(10) Pub. No.: US 2025/0061419 A1
(43) Pub. Date: Feb. 20, 2025

(54) SYSTEMS AND PROCESSES FOR DETECTING ANOMALIES IN SUPPLY CHAIN NETWORKS AND MANAGING INVENTORY EVENTS

(71) Applicant: Thrive Technologies, Inc., Marietta, GA (US)

(72) Inventor: Louis Rick Morris, Kennesaw, GA (US)

(21) Appl. No.: 18/806,429

(22) Filed: Aug. 15, 2024

Related U.S. Application Data
(63) Continuation of application No. PCT/US2024/042470, filed on Aug. 15, 2024.
(60) Provisional application No. 63/519,699, filed on Aug. 15, 2023.

(51) Int. Cl. G06Q 10/087; G06N 20/00

(52) U.S. Cl. CPC G06Q 10/087; G06N 20/00

(57) ABSTRACT

Systems and process for identifying anomalies and changes in supply chain networks, in real-time, are disclosed. The system leverages machine learning models trained on change point detection algorithms and historical supply chain data to detect supply chain network anomalies in real-time. The system can be operatively connected to, and receive data feeds from, supply chain entities and clients. The system can provide the received data feeds to the machine learning models to detect specific points in time at which a change occurs in a supply chain network. In response to identifying anomalies and changes in supply chain networks, the system can generate alerts or modification recommendations for one or more entities or clients in a supply chain network to mitigate against network inefficiencies resulting from the identified anomalies and changes in the supply chain network, or the system can automatically override inventory management configurations in the supply chain network.

### CROSS-REFERENCE TO RELATED APPLICATIONS

This application is a Continuation Patent Application of, and claims the benefit of and priority to International Patent Application No. PCT/US2024/042470, filed on Aug. 15, 2024, and entitled “SYSTEMS AND PROCESSES FOR DETECTING ANOMALIES IN SUPPLY CHAIN NETWORKS AND MANAGING INVENTORY EVENTS,” which claims the benefit of and priority to U.S. Provisional Patent Application No. 63/519,699, filed on Aug. 15, 2023, and entitled “SYSTEMS AND METHODS FOR MANAGING INVENTORY EVENTS,” the disclosures of which are incorporated by reference as if the same were fully set forth herein.

### TECHNICAL FIELD

The present systems and processes relate generally to monitoring, managing, and optimizing inventory, and more particularly to the early identification and detection of changes and anomalous events in supply chain networks.

### BACKGROUND

Managing inventory demand and supply is a key component to any successful retail or wholesale establishment. However, conventional supply chain technology fails to address various challenges faced by these establishments, such as handling unpredictable demand and supply, and responding more quickly and appropriately to changes in demand and supply.

Currently, inventory management systems are generally not equipped to respond appropriately and quickly enough when demand changes rapidly or when supply is unexpectedly being received later or sooner (or even lost). Thus, inventory managers are generally unaware of current changes to supply or demand when large scale projects are completed and demand levels may dip, or when high volume vendors have extended delays in fulfilling purchase orders. These unexpected and unaccounted for spikes or dips in supply and demand can lead to significant lost sales or excessive inventory.

In typical retail and wholesale establishments, and in conventional supply chain operations more generally, inventory stocking and purchasing is configured during an initial implementation and rarely (or never) adjusted. Accordingly, the impact of modifying stocking and purchasing after initial implementation, as well as the effectiveness of any current or modified inventory stocking and purchasing setting in an inventory management system, is generally unknown to and unmeasurable by these establishments.

Furthermore, many retail and wholesale establishments stock thousands of unique items sourced from thousands of suppliers, each of which requires unique supply and demand forecasting. Conventional inventory management systems are not equipped to handle forecasting variations and demand and supply changes for supply chain operations at this scale, nor are they equipped to modify inventory stocking and purchasing settings appropriately and quickly enough to effectively adjust to these demand and supply changes.

Thus, there exists an unresolved need for systems and methods that can identify and respond appropriately and more quickly to anomalous change in supply chain networks.

### BRIEF SUMMARY OF THE DISCLOSURE

Briefly described, and according to one embodiment, aspects of the present disclosure generally relate to systems and methods for monitoring, managing, and optimizing inventory, and more specifically, to systems and processes for early identification and detection of changes and anomalous events in supply chain networks.

In one non-limiting discussion example, consider a scenario in which an entity (e.g., a retailer, wholesaler, manufacturer, etc.) wants to reduce stockouts or excess inventory by limiting inventory issues caused by unpredictable changes in demand and supply. The entity may already use an inventory replenishment system to manage inventory levels; however, conventional inventory management systems do not respond quickly enough to changes in demand and supply. In this example, assume the entity is supplying materials to a client building a large construction project, which requires an increased amount of supplies to complete the project. Upon completion of the construction project, because traditional Enterprise Resource Planning (ERP) systems generally use a moving average to estimate future demand (such as next month's demand), the entity's ERP system (or other suitable inventory management system) is likely to continue to order supplies for this project, despite the project having been completed. This excess ordering of supplies is likely to continue month after month and could overload the entity's inventory by thousands of dollars (or more) by the time the demand change is identified and the loss of demand is recognized and the appropriate inventory levels are recalibrated.

Similarly, in another example, one of the entity's vendors may be experiencing supply chain issues whereby the vendor can no longer provide pipe fittings to the entity at their previously agreed upon schedule. Assume, for this example, that the entity's ERP system did not alert management to this issue, and thus several other construction projects were stalled due to the lack of pipe fittings needed to complete the projects. These construction delays likely cost the entity thousands of dollars (or more) in extra expenses and caused severe damage to the entity's goodwill.

Continuing with the above examples, the entity may desire a system that can integrate with, and access the data of, its current inventory management system to better identify and manage changes in demand and supply. The systems and methods described herein can, in one embodiment, integrate with inventory management systems to collect data and generate alerts and recommendations to better manage and optimally stock generally inconsistent demand and supply. In one embodiment of the present systems and methods, granular inventory data is collected from a distribution establishment. In various embodiments, the inventory data may be collected from a third-party inventory replenishment system (or other suitable system, such as an ERP system). In a particular embodiment, data may be collected or received from one or more entities, clients, or other data sources within a supply chain network. In certain embodiments, the inventory data may be manually uploaded into the system. In certain embodiments, the collected data is processed and analyzed to identify unprecedented demand at the outset of the necessity for such demand. In at least one embodiment, the collected data is processed and analyzed to identify a reduction in demand once such demand is no longer necessitated. In some embodiments, the collected data is processed and analyzed to also identify unexpected changes in supply (e.g., a vendor shipped product in six weeks but normally ships in two weeks). In particular embodiments, the processed data can be used to generate (and train) a machine learning model, such that future/subsequent changes in demand and supply can be identified and accurately addressed. In one or more embodiments, the system may integrate with a third-party ordering system to automatically optimize a forecast and/or replenishment settings for effected stock keeping units (SKUs) to reflect the changed demand or supply. In these embodiments (and others), the system may determine the order amount by analyzing the inventory data. In certain embodiments, the system may be configured to automatically adjust stocking levels to account for future changes in demand and supply.

Accordingly, as described above, aspects of the various embodiments described herein include training one or more machine learning (ML) algorithms using a given data model based on inventory data points, data received from supply chain network sources, various inventory rules/policies, etc. In some embodiments, the system may employ a LightGBM machine learning model to facilitate the systems and methods disclosed herein. As will be understood by a person having ordinary skill in the art, a LightGBM model is a gradient boosting framework that uses tree-based learning algorithms. In certain embodiments, the system may employ various machine learning models including, but not limited to: multiclass classification algorithms (e.g., multiclass logistic regression, multiclass neural network, multiclass decision forest, one-vs-all multiclass, multiclass boosted decision tree, etc.), latent Dirichlet allocation (LDA); term frequency-inverse document frequency (TF-IDF); k-means clustering; and any other algorithm or model suitable to perform the functions described herein. In particular embodiments, the system can leverage machine learning algorithms and models trained to perform change point detection on time-series data, such as data received from various nodes within a supply chain network.

In particular embodiments, the selected algorithm or model can be trained based on various data points regarding various SKUs and the accepted policy for handling a particular SKU with fluctuating demand and supply. Once trained, the model can be used for a given organization to track and optimally stock SKUs with generally erratic demand and supply, as well as implement procedures for timely replenishment of such identified SKUs. In some embodiments, the machine learning component facilitates continual learning as new demand and supply data is made available and/or the training set is updated and/or corrected.

In particular embodiments, the system may be operatively connected to, and can receive data from, supply chain entities and clients. In certain embodiments, the system can accept input data including, but not limited to: sales transactions (including timestamps, sales orders, customer identification numbers, items, locations, quantities, prices, etc.), unit cost, active status, stock status, on hand units, minimum order quantity, incremental order quantity, current minimums and/or maximums (if available), lead time, item origination/established date if available (that way a policy can identify new items and treat them differently), and one or more user-defined fields. In various embodiments, the input data may be from one entity or client (e.g., a single location); however, in certain embodiments, the input data may be from multiple entities or clients (e.g., multiple locations). In one or more embodiments, the system is configured to accept input data at system initialization to facilitate configuration and setup of the system. In these embodiments (and others), the system is configured to train the machine learning algorithm with the input data upon system initialization. In at least one embodiment, the system is configured to accept input data at various times during system operation (e.g., hourly, daily, weekly, monthly, etc.). In certain embodiments, the system may accept input data at any time as configured by a system user. In one or more embodiments, the data is ingested via a flat delimited file from an ERP system or entity/client data warehouse. In various embodiments, the data ingestion may be a scheduled automated data transfer. In some embodiments, the data ingestion may be initiated manually. In at least one embodiment, various scripts and APIs may facilitate data ingestion. In these embodiments (and others), Open Database Connectivity (ODBC) may facilitate data ingestion. In certain embodiments, data ingestion may occur at any suitable time (e.g., daily, weekly, monthly, quarterly, etc.). In particular embodiments, the system is configured to initiate the process described herein upon ingestion of new data. As will be understood by a person having ordinary skill in the art, the steps and processes shown in the drawings and discussed herein may operate concurrently and continuously, are generally asynchronous and independent, and are not necessarily performed in the order shown.

In various embodiments, upon initial ingestion of data, the system is configured to begin processing the data. In various embodiments, processing may occur on a schedule (e.g., daily, weekly, monthly, etc.). In some embodiments, processing may occur automatically and continuously. In one or more embodiments, processing includes analyzing SKU and supplier performance changes. For example, the system may identify a forty-five day old purchase order for a supplier that generally fulfills purchase orders in thirty days. In this example, the system may generate an alert regarding potential stock outs and include one or more recommended actions (e.g., confirm future ship dates with supplier, purchase from different supplier, etc.). In at least one embodiment, processing includes calculating an initial set of metrics to further facilitate training of a machine learning model and establishing one or more policies (as will be described further herein). In particular embodiments, the system may calculate metrics including, but not limited to: unprecedented demand, top customers who have stopped buying, and customer breadth. In these embodiments (and others), unprecedented demand identifies a recent month of demand that is a predetermined amount higher than any prior month of demand within a predetermined time period (e.g., twelve months, eighteen months, twenty-four months, etc.) and the machine learning algorithms examine various data characteristics to determine this new level of demand is likely to continue. In some embodiments, the predetermined amount may be a percentage (e.g., fifteen percent, twenty-five percent, forty percent, etc.). In at least one embodiment, the predetermined amount may be a dollar amount (e.g., $5,000, $15,000, $40,000, etc.). In some embodiments, if a recent month of demand is a predetermined amount higher than any prior month of demand within a predetermined time period, then the system may send an alert indicating the occurrence of unprecedented demand. In one or more embodiments, the system may be configured to initiate and/or adjust a purchase order with the appropriate vendor to account for necessary inventory adjustments as a result of unprecedented demand. In various embodiments, unprecedented demand may identify a recent month of demand that is a predetermined amount lower than any prior month of demand within a predetermined time period. In some embodiments, unprecedented demand may assess demand at various intervals (e.g., sustained high or low demand over several months, sustained high or low demand over several days, etc.). For example, in one or more embodiments, unprecedented demand may be identified for a product that sold four times higher over the past month than its average sales over the previous six months. In another example, in certain embodiments, unprecedented demand may be identified for a product that sold two and a half times lower over the past three weeks than its average over the previous three months. In still another example, unprecedented demand may be identified for a product where there is a significant increase (e.g., twenty-five percent, fifty percent, one hundred percent, greater than one hundred percent, etc.) in the number of distinct customers to whom the product is sold.

In certain embodiments, and for a given user, client, or entity, the system is configured to calculate and identify recent demand changes corresponding to one or more top customers. For example, the system may calculate and identify demand changes corresponding to top customers by: 1) identifying SKUs in each location that are purchased primarily by one customer; 2) calculating the average interval of time between sales; 3) calculating the total sales dollars in the last twelve months; 4) calculating sales to each customer identified in step 1; 5) calculating the percentage of each identified SKU purchased by one customer; 6) if the percentage calculated in step 5 is greater than a predetermined threshold, then calculating the most recent interval of time between sales; and 7) identifying if the most recent interval of time between sales is greater than the average interval of time between sales. In some embodiments, if at step 7 the most recent interval of time between sales is greater than the average interval of time between sales, then system may be configured to send out an alert of a potential lost customer. In various embodiments, if at step 7 the most recent interval of time between sales is greater than the average interval of time between sales, then the system may transmit a message to the salesperson for that account to validate if the client is no longer buying that SKU.

In particular embodiments, the system is configured to calculate the customer breadth for a given user or entity. As used herein, the customer breadth may refer to the total number of customers that has purchased a particular SKU in a predetermined timeframe (e.g., twelve months, eighteen months, twenty-four months, etc.). In certain embodiments, the system may be configured to send out an unprecedented demand alert only if unprecedented demand is identified for a particular SKU and customer breadth exceeds a predetermined threshold (e.g., five customers, fifteen customers, thirty customers, etc.). In one or more embodiments, the predetermined threshold is user configurable. In some embodiments, the system may also generate a recommendation for responding to an unprecedented demand alert (e.g., the system may recommend adjusting the “demand” or “forecast” setting in the ERP system to shorten the prior time demand window so that the ERP forecast algorithms only consider the most recent demand). In at least one embodiment, the system may automatically apply a recommended setting in response to an unprecedented demand alert.

In particular embodiments, the system may calculate a baseline for demand to delineate a general starting point for the system to assess actionable changes in demand of a particular SKU. In some embodiments, the system may calculate a baseline for demand by analyzing the inventory data and identifying SKUs with a large customer concentration of high dollar products (e.g., a construction company may identify wood, windows, floor panels, etc.). In one or more embodiments, the inventory data analyzed may include historical sales data, customer identification numbers, quantities purchased, dates sold, sales price, and any other suitable data that facilitates the baseline calculation. In various embodiments, once a baseline has been calculated for a particular SKU, the system may be configured to monitor the SKU (e.g., weekly, monthly, etc.) and send the user an alert when demand deviates at a predetermined threshold from the calculated baseline (i.e., actionable deviation). In these embodiments, demand may deviate due to the loss of a high impact client, the gain of a new high impact client, a possible shift in demand to another SKU, or any other suitable reason for a shift (or tilt) in demand. In at least one embodiment, the actionable deviation may be the percentage of a SKU that is bought by a particular customer (e.g., seventy percent, eighty-five percent, etc.). In certain embodiments, the actionable deviation may be the dollar amount of a SKU that is bought by a particular customer (e.g., 1,000, $5,000, $25,000, etc.). In at least one embodiment, actionable deviation may be user configurable such that the system user determines the parameters that trigger an alert.

In various embodiments, the system may calculate a baseline for supply to delineate a general starting point for the system to assess actionable changes in supply of a particular SKU. In certain embodiments, the system may calculate a baseline for supply by analyzing the inventory data. In one or more embodiments, the inventory data analyzed may include historical sales data, customer identification numbers, quantities purchased, dates sold, sales price, and any other suitable data that facilitates the baseline calculation. In one or more embodiments, the system may calculate a baseline for supply by analyzing and comparing the purchase order dates versus the purchase order receipt dates for each SKU per location by each vendor. In certain embodiments, the system may then calculate the actual lead time and lead time deviation by each vendor per SKU. In some embodiments, the system may calculate the actual lead time and lead time deviation of only high dollar vendors (e.g., vendors with purchase orders over a predetermined threshold (e.g., $1,000, $5,000, $25,000, etc.), or vendors with purchase orders that constitute a predetermined percentage of total purchase orders (e.g., five percent, ten percent, etc.)). In various embodiments, once a baseline has been calculated for a particular SKU, the system may be configured to send the user an alert when lead time deviates by a predetermined amount from the calculated baseline (i.e., the actionable deviation). In some embodiments, the system may be configured to transmit a message to a vendor whose lead time deviates by a predetermined amount from the calculated baseline. In these embodiments (and others), the message may contain a description of the deviation and/or a request to contact the Purchasing Manager or Supply Chain Manager. In one embodiment, actionable deviation may be a percentage (e.g., twenty-five percent, fifty percent, etc.). In another embodiment, actionable deviation may be a number of days (e.g., 7 days, 14 days, etc.). In yet another embodiment, actionable deviation may be the dollar amount of the purchase order (e.g., $1,000, $5,000, $25,000, etc.). In particular embodiments, actionable deviation may be user configurable such that the system user determines the parameters that trigger an alert.

In certain embodiments, the system may train a machine learning model or optimization model to establish an inventory policy based on user defined criteria. In these embodiments (and others), users may set rules independent of system analysis. In various embodiments, users may set rules that determine when the system sends alerts. Exemplary, illustrative, and non-limiting user defined rules may include:
generate an alert when the potential sales dollars lost are at least $10,000 annually; or do not generate an unprecedented demand alert for one large sale by one client; or if unprecedented demand was triggered by purchases of a particular SKU made by at least three distinct customers, then generate an alert; or if a customer that purchased at least 40% of the dollar volume of a particular SKU at a particular location over the last twelve months and the largest gap between purchases is two months, then generate an alert if that customer does not purchase the particular SKU in greater than 2 months.

As will be understood and appreciated, other policies and rules may be established based on specific data sets analyzed by the system; the policies and rules identified above are provided for illustrative and exemplary purposes only, and are not intended to limit the scope of the present disclosure.

In various embodiments, the system may generate an output data feed which may be returned to a third-party inventory management application for evaluation of the machine learning model. In one embodiment, the machine learning model can be evaluated internally by the system itself via one or more validation processes. In particular embodiments, the output data feed may be generated in any suitable format (e.g., spreadsheet, word document, graph, chart, etc.). In one or more embodiments, the system continually monitors performance and refine or re-trains the model if performance has shown degradation, or if new supply chain data is available. In certain embodiments, the system may output data to a third-party system (e.g., a business intelligence system) for further processing and analysis.

Moreover, this application incorporates by reference the following U.S. patent applications, the disclosures of which are incorporated by reference as if the same were fully set forth herein:
U.S. patent application Ser. No. 17/552,078, filed on Dec. 15, 2021, and entitled “SYSTEMS AND METHODS FOR INVENTORY CONTROL AND OPTIMIZATION”;
U.S. patent application Ser. No. 17/552,091, filed on Dec. 15, 2021, and entitled “SYSTEMS AND METHODS FOR INVENTORY CONTROL AND OPTIMIZATION”; and
U.S. patent application Ser. No. 18/296,271, filed on Apr. 5, 2023, and entitled “SYSTEMS AND PROCESSES FOR OPTIMIZING INVENTORY”.

According to a first aspect, the present disclosure sets forth a method, including: training, by one or more processors, a machine learning model based on historical enterprise resource planning (ERP) input data associated with a time series dataset and a corresponding training algorithm, wherein the historical ERP input data corresponds to one or more entities and one or more clients in a supply chain network; receiving additional input data from the one or more entities and/or from the one or more clients, wherein the additional input data represents real-time data from the supply chain network; detecting one or more discrete events in the additional input data, wherein the one or more discrete events are indicative of anomalous behavior in the supply chain network; determining one or more source nodes of the one or more discrete events indicative of anomalous behavior in the supply chain network, wherein the one or more source nodes include at least one entity or at least one client; and initiating one or more remediation actions based on the anomalous behavior detected from the one or more source nodes, wherein initiating the one or more remediation actions includes generating a modification to one or more inventory management configurations at the one or more entities and/or the one or more clients to adjust for the anomalous behavior detected from the one or more source nodes.

According to a second aspect, or any other aspect, the corresponding training algorithm includes a change point detection algorithm.

According to a third aspect, or any other aspect, the change point detection algorithm includes Bayesian change point criteria for detecting one or more discrete events in the additional input data, and wherein the Bayesian change point criteria include a predetermined posterior probability threshold and/or a Bayes factor.

According to a fourth aspect, or any other aspect, the change point detection algorithm includes kernel-based change point criteria for detecting one or more discrete events in the additional input data, and wherein the kernel-based change point criteria include kernel density estimates and shifts.

According to a fifth aspect, or any other aspect, prior to training the machine learning model, the method further includes generating one or more features based on the historical ERP input data, wherein the one or more features include measurable characteristics corresponding to identified patterns in the historical ERP input data.

According to a sixth aspect, or any other aspect, initiating the one or more remediation actions further includes overriding the one or more inventory management configurations at the one or more entities and/or the one or more clients to adjust for the anomalous behavior detected from the one or more source nodes.

According to a seventh aspect, or any other aspect, the historical ERP input data and the additional input data include multivariate data received from the one or more entities and the one or more clients in the supply chain network.

According to an eighth aspect, or any other aspect, the disclosure sets forth a system, including: a processor; and a memory on which are stored machine-readable instruction that when executed by the processor, cause the processor to: train a machine learning model based on historical enterprise resource planning (ERP) input data associated with a time series dataset and a corresponding training algorithm, wherein the historical ERP input data corresponds to one or more entities and one or more clients in a supply chain network; receive additional input data from the one or more entities and/or from the one or more clients, wherein the additional input data represents real-time data from the supply chain network; detect one or more discrete events in the additional input data, wherein the one or more discrete events are indicative of anomalous behavior in the supply chain network; determine one or more source nodes of the one or more discrete events indicative of anomalous behavior in the supply chain network, wherein the one or more source nodes include at least one entity or at least one client; and initiate one or more remediation actions based on the anomalous behavior detected from the one or more source nodes, wherein initiating the one or more remediation actions includes generating a modification to one or more inventory management configurations at the one or more entities and/or the one or more clients to adjust for the anomalous behavior detected from the one or more source nodes.

According to a nineth aspect, or any other aspect, the corresponding training algorithm includes a change point detection algorithm.

According to a tenth aspect, or any other aspect, the change point detection algorithm includes Bayesian change point criteria for detecting one or more discrete events in the additional input data, and wherein the Bayesian change point criteria include a predetermined posterior probability threshold and/or a Bayes factor.

According to an eleventh aspect, or any other aspect, the change point detection algorithm includes kernel-based change point criteria for detecting one or more discrete events in the additional input data, and wherein the kernel-based change point criteria include kernel density estimates and shifts.

According to a twelfth aspect, or any other aspect, prior to training the machine learning model, the processor is further caused to generate one or more features based on the historical ERP input data, wherein the one or more features include measurable characteristics corresponding to identified patterns in the historical ERP input data.

According to a thirteenth aspect, or any other aspect, initiating the one or more remediation actions further includes overriding the one or more inventory management configurations at the one or more entities and/or the one or more clients to adjust for the anomalous behavior detected from the one or more source nodes.

According to a fourteenth aspect, or any other aspect, the historical ERP input data and the additional input data include multivariate data received from the one or more entities and the one or more clients in the supply chain network.

According to a fifteenth aspect, the present disclosure sets forth a non-transitory computer readable medium including instructions, that when read by a processor, cause the processor to perform: training, by one or more processors, a machine learning model based on historical enterprise resource planning (ERP) input data associated with a time series dataset and a corresponding change point detection training algorithm, wherein the historical ERP input data corresponds to one or more entities and one or more clients in a supply chain network; receiving additional input data from the one or more entities and/or from the one or more clients, wherein the additional input data represents real-time data from the supply chain network; detecting one or more discrete events in the additional input data, wherein the one or more discrete events are indicative of anomalous behavior in the supply chain network; determining one or more source nodes of the one or more discrete events indicative of anomalous behavior in the supply chain network, wherein the one or more source nodes include at least one entity or at least one client; and initiating one or more remediation actions based on the anomalous behavior detected from the one or more source nodes, wherein initiating the one or more remediation actions includes generating a modification to one or more inventory management configurations at the one or more entities and/or the one or more clients to adjust for the anomalous behavior detected from the one or more source nodes.

According to a sixteenth aspect, or any other aspect, and regarding the non-transitory computer readable medium, the change point detection algorithm includes Bayesian change point criteria for detecting one or more discrete events in the additional input data, and wherein the Bayesian change point criteria include a predetermined posterior probability threshold and/or a Bayes factor.

According to a seventeenth aspect, or any other aspect, and regarding the non-transitory computer readable medium, the change point detection algorithm includes kernel-based change point criteria for detecting one or more discrete events in the additional input data, and wherein the kernel-based change point criteria include kernel density estimates and shifts.

According to an eighteenth aspect, or any other aspect, and regarding the non-transitory computer readable medium, prior to training the machine learning model, the processor is further caused to perform generating one or more features based on the historical ERP input data, wherein the one or more features include measurable characteristics corresponding to identified patterns in the historical ERP input data.

According to a nineteenth aspect, or any other aspect, and regarding the non-transitory computer readable medium, initiating the one or more remediation actions further includes overriding the one or more inventory management configurations at the one or more entities and/or the one or more clients to adjust for the anomalous behavior detected from the one or more source nodes.

According to a twentieth aspect, or any other aspect, and regarding the non-transitory computer readable medium, the historical ERP input data and the additional input data include multivariate data received from the one or more entities and the one or more clients in the supply chain network.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a diagram of an example system, according to one aspect of the present disclosure;

FIG. 2 is a flowchart of an example system configuration process, according to one aspect of the present disclosure; and

FIG. 3 is a flowchart of an example system operation process, according to one aspect of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to systems and methods for monitoring, managing, and optimizing inventory, and more particularly to systems and processes for early identification and detection of changes and anomalous events in supply chain networks.

In one non-limiting discussion example, consider a scenario in which an entity (e.g., a retailer, wholesaler, manufacturer, etc.) wants to reduce stockouts or excess inventory by limiting inventory issues caused by unpredictable changes in demand and supply. The entity may already use an inventory replenishment system to manage inventory levels; however, conventional inventory management systems do not respond quickly enough to changes in demand and supply. In this example, assume the entity is supplying materials to a client building a large construction project, which requires an increased amount of supplies to complete the project. Upon completion of the construction project, because traditional Enterprise Resource Planning (ERP) systems generally use a moving average to estimate future demand (such as next month's demand), the entity's ERP system (or other suitable inventory management system) is likely to continue to order supplies for this project, despite the project having been completed. This excess ordering of supplies is likely to continue month after month and could overload the entity's inventory by thousands of dollars (or more) by the time the demand change is identified and the loss of demand is recognized and the appropriate inventory levels are recalibrated.

Similarly, in another example, one of the entity's vendors may be experiencing supply chain issues whereby the vendor can no longer provide pipe fittings to the entity at their previously agreed upon schedule. Assume, for this example, that the entity's ERP system did not alert management to this issue, and thus several other construction projects were stalled due to the lack of pipe fittings needed to complete the projects. These construction delays likely cost the entity thousands of dollars (or more) in extra expenses and caused severe damage to the entity's goodwill.

Continuing with the above examples, the entity may desire a system that can integrate with, and access the data of, its current inventory management system to better identify and manage changes in demand and supply. The systems and methods described herein can, in one embodiment, integrate with inventory management systems to collect data and generate alerts and recommendations to better manage and optimally stock generally inconsistent demand and supply. In one embodiment of the present systems and methods, granular inventory data is collected from a distribution establishment. In various embodiments, the inventory data may be collected from a third-party inventory replenishment system (or other suitable system, such as an ERP system). In a particular embodiment, data may be collected or received from one or more entities, clients, or other data sources within a supply chain network. In certain embodiments, the inventory data may be manually uploaded into the system. In certain embodiments, the collected data is processed and analyzed to identify unprecedented demand at the outset of the necessity for such demand. In at least one embodiment, the collected data is processed and analyzed to identify a reduction in demand once such demand is no longer necessitated. In some embodiments, the collected data is processed and analyzed to also identify unexpected changes in supply (e.g., a vendor shipped product in six weeks but normally ships in two weeks). In particular embodiments, the processed data can be used to generate (and train) a machine learning model, such that future/subsequent changes in demand and supply can be identified and accurately addressed. In one or more embodiments, the system may integrate with a third-party ordering system to automatically replenish particular stock keeping units (SKUs) upon adjustment for changed demand or supply. In these embodiments (and others), the system may determine the order amount by analyzing the inventory data. In certain embodiments, the system may be configured to automatically adjust stocking levels to account for future changes in demand and supply.

Accordingly, as described above, aspects of the various embodiments described herein include training one or more machine learning (ML) algorithms using a given data model based on inventory data points, data received from supply chain network sources, various inventory rules/policies, etc. In some embodiments, the system may employ a LightGBM machine learning model to facilitate the systems and methods disclosed herein. As will be understood by a person having ordinary skill in the art, a LightGBM model is a gradient boosting framework that uses tree-based learning algorithms. In certain embodiments, the system may employ various machine learning models including, but not limited to: multiclass classification algorithms (e.g., multiclass logistic regression, multiclass neural network, multiclass decision forest, one-vs-all multiclass, multiclass boosted decision tree, etc.), latent Dirichlet allocation (LDA); term frequency-inverse document frequency (TF-IDF); k-means clustering; and any other algorithm or model suitable to perform the functions described herein. In particular embodiments, the system can leverage machine learning algorithms and models trained to perform change point detection on time-series data, such as data received from various nodes within a supply chain network.

In particular embodiments, the selected algorithm or model can be trained based on various data points regarding various SKUs and the accepted policy for handling a particular SKU with fluctuating demand and supply. Once trained, the model can be used for a given organization to track and optimally stock SKUs with generally erratic demand and supply, as well as implement procedures for timely replenishment of such identified SKUs. In some embodiments, the machine learning component facilitates continual learning as new demand and supply data is made available and/or the training set is updated and/or corrected.

In particular embodiments, the system may be operatively connected to, and can receive data from, supply chain entities and clients. In certain embodiments, the system can accept input data including, but not limited to: sales transactions (including timestamps, sales orders, customer identification numbers, items, locations, quantities, prices, etc.), unit cost, active status, stock status, on hand units, minimum order quantity, incremental order quantity, current minimums and/or maximums (if available), lead time, item origination/established date if available (that way a policy can identify new items and treat them differently), and one or more user-defined fields. In various embodiments, the input data may be from one entity or client (e.g., a single location); however, in certain embodiments, the input data may be from multiple entities or clients (e.g., multiple locations). In one or more embodiments, the system is configured to accept input data at system initialization to facilitate configuration and setup of the system. In these embodiments (and others), the system is configured to train the machine learning algorithm with the input data upon system initialization. In at least one embodiment, the system is configured to accept input data at various times during system operation (e.g., hourly, daily, weekly, monthly, etc.). In certain embodiments, the system may accept input data at any time as configured by a system user. In one or more embodiments, the data is ingested via a flat delimited file from an ERP system or entity/client data warehouse. In various embodiments, the data ingestion may be a scheduled automated data transfer. In some embodiments, the data ingestion may be initiated manually. In at least one embodiment, various scripts and APIs may facilitate data ingestion. In these embodiments (and others), Open Database Connectivity (ODBC) may facilitate data ingestion. In certain embodiments, data ingestion may occur at any suitable time (e.g., daily, weekly, monthly, quarterly, etc.). In particular embodiments, the system is configured to initiate the process described herein upon ingestion of new data. As will be understood by a person having ordinary skill in the art, the steps and processes shown in the drawings and discussed herein may operate concurrently and continuously, are generally asynchronous and independent, and are not necessarily performed in the order shown.

In various embodiments, upon initial ingestion of data, the system is configured to begin processing the data. In various embodiments, processing may occur on a schedule (e.g., daily, weekly, monthly, etc.). In some embodiments, processing may occur automatically and continuously. In one or more embodiments, processing includes analyzing SKU and supplier performance changes. For example, the system may identify a forty-five day old purchase order for a supplier that generally fulfills purchase orders in thirty days. In this example, the system may generate an alert regarding potential stock outs and include one or more recommended actions (e.g., confirm future ship dates with supplier, purchase from different supplier, etc.). In at least one embodiment, processing includes calculating an initial set of metrics to further facilitate training of a machine learning model and establishing one or more policies (as will be described further herein). In particular embodiments, the system may calculate metrics including, but not limited to: unprecedented demand, top customers who have stopped buying, and customer breadth. In these embodiments (and others), unprecedented demand identifies a recent month of demand that is a predetermined amount higher than any prior month of demand within a predetermined time period (e.g., twelve months, eighteen months, twenty-four months, etc.) and the machine learning algorithms examine various data characteristics to determine this new level of demand is likely to continue. In some embodiments, the predetermined amount may be a percentage (e.g., fifteen percent, twenty-five percent, forty percent, etc.). In at least one embodiment, the predetermined amount may be a dollar amount (e.g., $5,000, $15,000, $40,000, etc.). In some embodiments, if a recent month of demand is a predetermined amount higher than any prior month of demand within a predetermined time period, then the system may send an alert indicating the occurrence of unprecedented demand. In one or more embodiments, the system may be configured to initiate and/or adjust a purchase order with the appropriate vendor to account for necessary inventory adjustments as a result of unprecedented demand. In various embodiments, unprecedented demand may identify a recent month of demand that is a predetermined amount lower than any prior month of demand within a predetermined time period. In some embodiments, unprecedented demand may assess demand at various intervals (e.g., sustained high or low demand over several months, sustained high or low demand over several days, etc.). For example, in one or more embodiments, unprecedented demand may be identified for a product that sold four times higher over the past month than its average sales over the previous six months. In another example, in certain embodiments, unprecedented demand may be identified for a product that sold two and a half times lower over the past three weeks than its average over the previous three months. In still another example, unprecedented demand may be identified for a product where there is a significant increase (e.g., twenty-five percent, fifty percent, one hundred percent, greater than one hundred percent, etc.) in the number of distinct customers to whom the product is sold.

In certain embodiments, and for a given user, client, or entity, the system is configured to calculate and identify recent demand changes corresponding to one or more top customers. For example, the system may calculate and identify demand changes corresponding to top customers by: 1) identifying SKUs in each location that are purchased primarily by one customer; 2) calculating the average interval of time between sales; 3) calculating the total sales dollars in the last twelve months; 4) calculating sales to each customer identified in step 1; 5) calculating the percentage of each identified SKU purchased by one customer; 6) if the percentage calculated in step 5 is greater than a predetermined threshold, then calculating the most recent interval of time between sales; and 7) identifying if the most recent interval of time between sales is greater than the average interval of time between sales. In some embodiments, if at step 7 the most recent interval of time between sales is greater than the average interval of time between sales, then system may be configured to send out an alert of a potential lost customer. In various embodiments, if at step 7 the most recent interval of time between sales is greater than the average interval of time between sales, then the system may transmit a message to the salesperson for that account to validate if the client is no longer buying that SKU.

In particular embodiments, the system is configured to calculate the customer breadth for a given user or entity. As used herein, the customer breadth may refer to the total number of customers that has purchased a particular SKU in a predetermined timeframe (e.g., twelve months, eighteen months, twenty-four months, etc.). In certain embodiments, the system may be configured to send out an unprecedented demand alert only if unprecedented demand is identified for a particular SKU and customer breadth exceeds a predetermined threshold (e.g., five customers, fifteen customers, thirty customers, etc.). In one or more embodiments, the predetermined threshold is user configurable. In some embodiments, the system may also generate a recommendation for responding to an unprecedented demand alert (e.g., the system may recommend adjusting the “demand” or “forecast” setting in the ERP system to shorten the prior time demand window so that the ERP forecast algorithms only consider the most recent demand). In at least one embodiment, the system may automatically apply a recommended setting in response to an unprecedented demand alert.

In particular embodiments, the system may calculate a baseline for demand to delineate a general starting point for the system to assess actionable changes in demand of a particular SKU. In some embodiments, the system may calculate a baseline for demand by analyzing the inventory data and identifying SKUs with a large customer concentration of high dollar products (e.g., a construction company may identify wood, windows, floor panels, etc.). In one or more embodiments, the inventory data analyzed may include historical sales data, customer identification numbers, quantities purchased, dates sold, sales price, and any other suitable data that facilitates the baseline calculation. In various embodiments, once a baseline has been calculated for a particular SKU, the system may be configured to monitor the SKU (e.g., weekly, monthly, etc.) and send the user an alert when demand deviates at a predetermined threshold from the calculated baseline (i.e., actionable deviation). In these embodiments, demand may deviate due to the loss of a high impact client, the gain of a new high impact client, a possible shift in demand to another SKU, or any other suitable reason for a shift (or tilt) in demand. In at least one embodiment, the actionable deviation may be the percentage of a SKU that is bought by a particular customer (e.g., seventy percent, eighty-five percent, etc.). In certain embodiments, the actionable deviation may be the dollar amount of a SKU that is bought by a particular customer (e.g., 1,000, $5,000, $25,000, etc.). In at least one embodiment, actionable deviation may be user configurable such that the system user determines the parameters that trigger an alert.

In various embodiments, the system may calculate a baseline for supply to delineate a general starting point for the system to assess actionable changes in supply of a particular SKU. In certain embodiments, the system may calculate a baseline for supply by analyzing the inventory data. In one or more embodiments, the inventory data analyzed may include historical sales data, customer identification numbers, quantities purchased, dates sold, sales price, and any other suitable data that facilitates the baseline calculation. In one or more embodiments, the system may calculate a baseline for supply by analyzing and comparing the purchase order dates versus the purchase order receipt dates for each SKU per location by each vendor. In certain embodiments, the system may then calculate the actual lead time and lead time deviation by each vendor per SKU. In some embodiments, the system may calculate the actual lead time and lead time deviation of only high dollar vendors (e.g., vendors with purchase orders over a predetermined threshold (e.g., $1,000, $5,000, $25,000, etc.), or vendors with purchase orders that constitute a predetermined percentage of total purchase orders (e.g., five percent, ten percent, etc.)). In various embodiments, once a baseline has been calculated for a particular SKU, the system may be configured to send the user an alert when lead time deviates by a predetermined amount from the calculated baseline (i.e., the actionable deviation). In some embodiments, the system may be configured to transmit a message to a vendor whose lead time deviates by a predetermined amount from the calculated baseline. In these embodiments (and others), the message may contain a description of the deviation and/or a request to contact the Purchasing Manager or Supply Chain Manager. In one embodiment, actionable deviation may be a percentage (e.g., twenty-five percent, fifty percent, etc.). In another embodiment, actionable deviation may be a number of days (e.g., 7 days, 14 days, etc.). In yet another embodiment, actionable deviation may be the dollar amount of the purchase order (e.g., $1,000, $5,000, $25,000, etc.). In particular embodiments, actionable deviation may be user configurable such that the system user determines the parameters that trigger an alert.

In certain embodiments, the system may train a machine learning model or optimization model to establish an inventory policy based on user defined criteria. In these embodiments (and others), users may set rules independent of system analysis. In various embodiments, users may set rules that determine when the system sends alerts. Exemplary, illustrative, and non-limiting user defined rules may include:
generate an alert when the potential sales dollars lost are at least $10,000 annually; or do not generate an unprecedented demand alert for one large sale by one client; or if unprecedented demand was triggered by purchases of a particular SKU made by at least three distinct customers, then generate an alert; or if a customer that purchased at least 40% of the dollar volume of a particular SKU at a particular location over the last twelve months and the largest gap between purchases is two months, then generate an alert if that customer does not purchase the particular SKU in greater than 2 months.

As will be understood and appreciated, other policies and rules may be established based on specific data sets analyzed by the system; the policies and rules identified above are provided for illustrative and exemplary purposes only, and are not intended to limit the scope of the present disclosure.

In various embodiments, the system may generate an output data feed which may be returned to a third-party inventory management application for evaluation of the machine learning model. In one embodiment, the machine learning model can be evaluated internally by the system itself via one or more validation processes. In particular embodiments, the output data feed may be generated in any suitable format (e.g., spreadsheet, word document, graph, chart, etc.). In one or more embodiments, the system continually monitors performance and refine or re-trains the model if performance has shown degradation, or if new supply chain data is available. In certain embodiments, the system may output data to a third-party system (e.g., a business intelligence system) for further processing and analysis.

### Example Embodiments

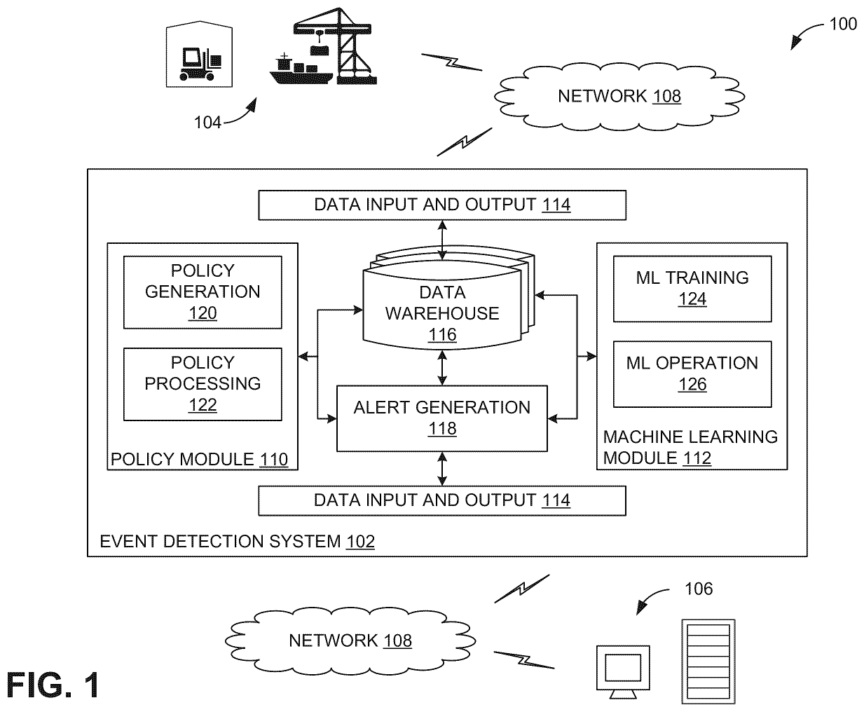

Referring now to the figures, for the purposes of example and explanation of the fundamental processes and components of the disclosed systems and processes, reference is made to FIG. 1, which is a diagram of an example system and operational environment 100, according to one aspect of the present disclosure.

In various embodiments, the operational environment 100 as illustrated in FIG. 1 depicts an event detection system 102 located in between, and generally in operative connection with, one or more entities 104 and one or more clients 106. In at least one embodiment, the entities 104 (which are illustrated, for example purposes, as warehouse and freight equipment) can be suppliers, vendors, distributors, producers, or generally any organization that may generate, control, influence, inject, etc., a supply of goods/materials in one or more supply chains or supply chain networks. In a particular embodiment, the clients 106 (which are illustrated, for example purposes, as computers and servers) can be consumers, customers, vendors, distributors, buyers, wholesalers, or generally any organization that may generate a demand for, or consume supply of, goods/materials in one or more supply chains or supply chain networks. As will be understood by one of ordinary skill in the art, supply chain networks can include an inherent latency that often results in network inefficiencies. For example, supply chain network latency can result in a decrease in client 106 demand not being received by, and adjusted for, by an entity 104 within a period of time sufficient to allow for the entity 104 to perform one or more mitigating actions. In another example, latency and inefficiencies can result in a decrease in an entity's 104 supply not being recognized, or otherwise known by, a client 106 within a period of time sufficient to allow for the client to initiate a remediating action. Moreover, given supply chain networks largely comprise computing devices configured to operate automatically and without human oversight, latency in supply chain networks is a technical problem that requires a technical solution. Moreover, given supply chain networks largely comprise computing devices configured to operate automatically and without human oversight, identifying and adjusting for detected anomalies in a supply chain network in real-time protects the integrity of the supply chain network as a whole by preventing incongruous network nodes/sources from inadvertently creating adverse supply chain network conditions (e.g., excess supply, insufficient supply, long lead times, etc.). In one embodiment, the event detection system 102 discussed herein solves these technical problems (and others) by leveraging one or more machine learning (ML) algorithms and trained ML models to detect changes and anomalous activity in a supply chain network in real-time, and furthermore by modifying the supply chain network accordingly. For example, the event detection system 102 can be configured to automatically modify inventory management settings in an ERP system (or other systems) based on the ML model outputs and other determinations discussed herein.

According to various aspects of the present disclosure, the event detection system 102, entities 104, and clients 106, can each be operatively connected over a network 108. In various embodiments, the network 108 may be a wired or wireless network (e.g., ethernet, LAN, WLAN, etc.).

In at least one example, the event detection system 102 can include a policy module 110 and a machine learning (ML) module 112 for detecting anomalies and other events within a supply chain network. As will be described in greater detail below, the policy module 110 and the ML module 112 can both be uniquely operatively configured to receive data from entities 104 and clients 106, and to subsequently process the received data for determining whether an anomaly or event has occurred within a supply chain network. Moreover, the policy module 110 and the ML module 112 can be operatively configured to generate alerts, recommendations, suggested remediations, etc., based on a detected anomaly or event. In certain embodiments, the policy module can recommend for a modification to be made to the supply chain network based on the detected anomaly.

In particular embodiments, the event detection system 102 can include one or more data input and output 114 modules. In various embodiments, the data input and output modules 114 can be operatively configured to integrate with the entities 104 and clients 106 for receiving input data feeds and outputting data feeds, alerts, notifications, recommendations, etc. In various embodiments, a data input feed can include (but is not limited to) sales transactions (including timestamps, sales orders, customer identification numbers, items, locations, quantities, prices, etc.), unit cost, active status, stock status, on hand units, minimum order quantity, incremental order quantity, current minimums and/or maximums (if exists), lead time, item origination/established date if available (that way a policy can identify new items and treat them differently), one or more user-defined fields, etc. In various embodiments, the input data may be from one entity 104 (e.g., a single location), however, in certain embodiments, the input data may be from multiple entities 104 (e.g., multiple locations). In one or more embodiments, the system is configured to accept input data at system initialization to facilitate configuration and setup of the system. In at least one example, a data output feed can include (but is not limited to) active status, stock status, top customer demand changes, SKUs with nonanomalous demand change, top supplier lead time changes, alerts or notifications regarding to detected changes, recommendations for responding to detected changes, etc.

In various embodiments, the event detection system 102 can include a data warehouse 116. According to various aspects of the present disclosure, a data warehouse can be one or more databases operatively configured to receive and store data from a data input feed. In at least one embodiment, the data warehouse 116 can include raw, preprocessed, or processed data including sales transactions (including timestamps, sales orders, customer identification numbers, items, locations, quantities, prices), unit cost, active status, stock status, on hand units, minimum order quantity, incremental order quantity, current minimums and/or maximums (if available), lead time, item origination/established date if available (that way a policy can identify new items and treat them differently), and one or more user-defined fields. In various embodiments, the data warehouse 116 can include data such as data feeds received from one or more supply chain networks sources or nodes, on-hand dollars for entities and/or clients, demand and historical forecasts, top customers, top suppliers, information corresponding to unprecedented demand, etc.

In various embodiments, the system can integrate diverse data types such as sales records, inventory levels and supplier performance. In particular embodiments, this multivariate data may be more complex than single-variable time series analysis in other domains. According to various aspects of the present disclosure, detecting change points involves understanding correlations between different variables, such as how supplier delays affect sales. In one embodiment, the disclosed system has access to both supply and demand sides, and thus the system can identify correlations in supply chain network data that other conventional systems are not capable of identifying.

In at least one embodiment, the event detection system 102 includes an alert generation module 118. In particular embodiments, the alert generation module 118 can be operatively connected to the data input and output module 114, the data warehouse 116, the policy module 110, and the machine learning module 112. According to various aspects of the present disclosure, the system can generate real-time alerts for inventory managers when, for example, the machine learning module 112 detects significant changes or anomalies. In various embodiments, generated alerts can be sent via email, text/SMS message, or integrated into an inventory management dashboard (for example, which may be a GUI or the like at an entity 104 or client 106 and can allow for the entity or client to control/access the event detection system 102). In certain embodiments, the system 102 can override a preexisting ERP setting to adjust for a detected supply chain anomaly. In at least one embodiment, the alert generation system 118 can perform insights reporting. In various embodiments, insights reporting can include providing detailed reports and visualizations that offer insights into the detected changes, including potential causes and recommended actions.

In various embodiments, the policy module 110 can be operatively configured to perform at least policy generation 120 and policy processing 122. In one embodiment, policy generation 120 via the policy module 110 can include determining rules for inventory management, stocking, etc., for SKUs that meet certain criteria (e.g., criteria indicative of unpredictable demand or supply forecasting). In one embodiment, the system may create a new inventory policy or stocking rule based on user, or client 106, input. In these embodiments (and others), a user may facilitate creation of a new inventory policy or stocking rule with a single SKU or by grouping one or more SKUs together (e.g., using Boolean expressions). In various embodiments, the system may create a new inventory policy or stocking rule by: 1) specifying which SKUs are to be affected (e.g., product category, location, etc.); 2) specifying the characteristic of the SKU (e.g., the SKU has sold twice as much in the last two months than it did in the prior twelve months; the SKU has historically been purchased by one customer but in the last month it was purchased by twelve customers, etc.); and 3) defining the action that should be taken by the system (e.g., generate and send an email to the user containing a report with alerts of the SKUs that meet the conditions specified in step 2; change the settings in the system to only use the most recent demand history in order to forecast more like the recent demand and less like the old demand; adjust the lead times in the system if the supplier lead time has increased by a predetermined percentage, etc.). In certain embodiments, the system may identify limits or cut-off values for inclusion in a new inventory policy or stocking rule. For example, the system may identify a top customer as a customer whose percentage of total sales is X percent (where X may be any natural number). In another example, the system may identify a large change in demand and supply as X percent change in last Y months as compared to the Z month average (where X, Y, and Z may be natural numbers). In particular embodiments, the system may automatically generate an inventory policy or stocking rule (for example, in response to a ML module output).

In one embodiment, an inventory policy or stocking rule can refer to a plan of action for a particular SKU that has met particular conditions. An example of an inventory policy may be that for SKUs under $500, generate an unprecedented demand alert when sales volume increases by twenty-five percent. Another example of an inventory policy may be that for vendors providing less than three percent of total inventory, only generate a lost supply alert for SKUs over $1,000. Yet another inventory policy example may be to exclude Customer X or Vendor Y from unprecedented demand and/or lost supply monitoring. In various embodiments, a user may accept, reject, or modify an inventory policy as implemented or recommended by the system. In certain embodiments, the system may run simulations of estimated inventory, demand, supply, and other metrics, as adjusted for one or more inventory policies. In particular embodiments, the system stores each inventory policy in a database (e.g., the data warehouse 116).

In various embodiments, the inventory policies and/or stocking rules may be executed via policy processing 122 of the policy module 110. According to various aspects of the present disclosure, data feeds received at the data input and output modules 114 can be routed to the policy processing module 122 for processing (e.g., real-time, batched, continuous, etc.).

Continuing with FIG. 1, in one embodiment, the machine learning (ML) module 112 can be operatively configured to perform at least ML training 124 and ML operation 126. According to various aspects of the present disclosure, the system, via the ML module 112, can employ one or more algorithms that leverage change point detection in order to detect, identify, and determine specific points in time indicative of a supply change event or anomaly. In various embodiments, change point detection is a statistical processing technique for identifying points in time where the behavior of a time series dataset changes significantly, or by a predetermined about (e.g., one standard deviation, two standard deviations, etc.). In one embodiment, the system is operatively configured to perform change point detection analysis on demand and supply behaviors (received via the data input and output modules 114 and/or stored within the data warehouse 116), which includes identifying specific moments in time when significant deviations occur from established patterns. In particular embodiments, the system is operatively configured to identify when purchasing behaviors change, such as sudden increases in demand or extended lead times, allowing system users to take proactive measures.

In various embodiments, the system is configured to operate on a granular scale, analyzing data across potentially many thousands of SKUs and locations in a retail or wholesale portfolio. According to various aspects of the present disclosure, by continuously monitoring and detecting these critical shifts, the system provides actionable insights that enable inventory managers to adjust their strategies promptly, ensuring optimal inventory levels and improved supply chain efficiency. In various embodiments, the system's ability to detect these change points accurately and in real-time mitigates against experiencing stockouts or overstock situations, thereby enhancing overall operational performance.

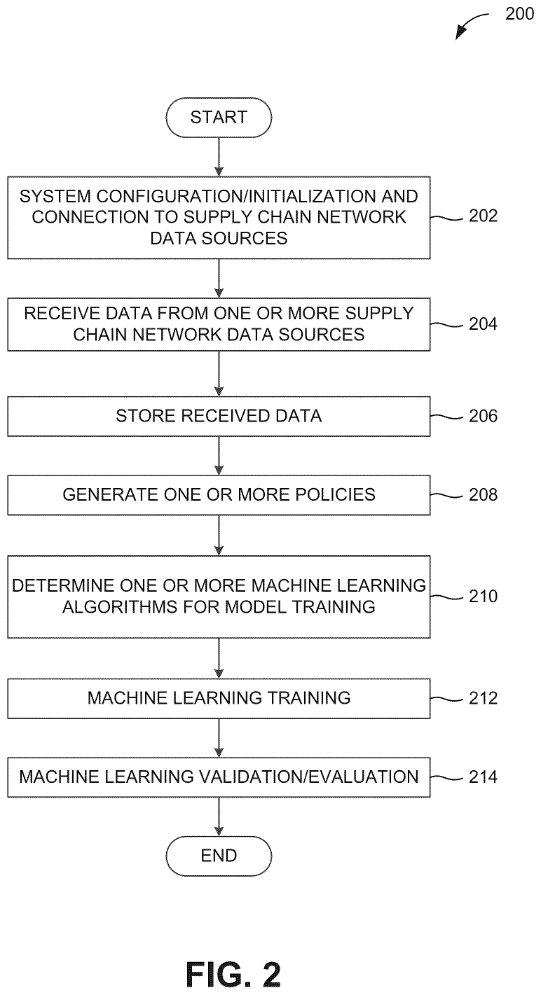

In one embodiment, FIG. 2 shows a flowchart of a system configuration and initialization process 200. According to various aspects of the present disclosure, the system configuration and initialization process 200 generally involves establishing network connections with external data feeds and data sources (nodes in a supply chain network), as well as connections with internal processing modules, for enabling policy processing, ML processing, and other system operations.

In various embodiments, at step 202, the system can establish connections to/with one or more data sources. In certain embodiments, the data sources can be entities 104, clients 106, or generally any appropriate third-party data source from which a data feed can be received. In at least one embodiment, the one or more data sources can be computing devices, or nodes, in a supply chain network. In a particular embodiment, connecting to the one or more data sources can include integrating with an inventory replenishment system, and ERP system, or the like. The system can be operatively configured to communicate with the one or more data sources via APIs, networks communication protocols, etc. In at least one embodiment, at step 202, the system can be configured to establish a frequency corresponding to how often data should be received from, or requested from, the one or more data sources to which it connects. In various embodiments, the system can subscribe to (or a user can generally select) the types of data to be received from each data source connection (for example, sales transactions data, on-hand units data, lead time data, etc.).

According to various embodiments, at step 204 the system is configured to receive data from the one or more connected data sources. In particular embodiments, the data can be received continuously, in real-time, in batches, in response to particular events occurring or being detected, and/or according to a predetermined schedule.

In one embodiment, at step 206 the system is configured to store the received data. As discussed herein, the system can include a data warehouse 116. In at least one example, the data warehouse 116 can be one or more databases configured to store supply chain network data in various formats. In particular embodiments, the data warehouse 116 can include specific memory locations for individual entities 104, clients 106, policies, ML algorithms and models, alerts/recommendations, etc.

At step 208, in various embodiments, the system can generate one or more policies. As discussed above in connection with the description of the policy module 110 of FIG. 1, an inventory policy or stocking rule can be a plan of action, an algorithm, a process, etc., for a particular SKU that has met particular conditions. An example of an inventory policy may be that for SKUs under $500, generate an unprecedented demand alert when sales volume increases by twenty-five percent. Another example of an inventory policy may be that for vendors providing less than three percent of total inventory, only generate a lost supply alert for SKUs over $1,000. Yet another inventory policy example may be to exclude Customer X or Vendor Y from unprecedented demand and/or lost supply monitoring. In various embodiments, a system user may accept, reject, or modify an inventory policy as implemented or recommended by the system. In certain embodiments, the system may run simulations of estimated inventory, demand, supply, and other metrics, as adjusted for one or more inventory policies. In particular embodiments, the system can store each inventory policy in a database (e.g., the data warehouse 116). According to various aspects of the present disclosure, the ML module 112 can generate policies, or generate recommendation for policies, based on changes detected in supply chain network data. In at least one embodiment, policies can be configured by system users (or automatically by the system itself) to include specific rules, Boolean expressions, cut-off values, etc. For example, a policy can be configured to exclude certain items or SKUs from particular inventory categories, a policy can be configured to exclude specific SKUs or categories of inventory from alert generation, etc. In particular embodiments, policies can be generated using policy templates (stored in the data warehouse 116) or from scratch using any appropriate SKU grouping and Boolean expressions (or other logical programming techniques/languages).

At step 210, and in various embodiments, the system can determine (or select) one or more machine learning (ML) algorithms for model training. According to various aspects of the present disclosure, the system can leverage ML algorithms specifically configured and trained for change point detection and for identifying particular points in time where behavior of a time series dataset significantly changes. In certain embodiments, determining a type of change point algorithm for training includes considering various factors, such as the algorithm's computational complexity and specific requirements of the system outputs. For example, determining one or more ML algorithms for model training can include analyzing characteristics of the time series data, such as noise presence, seasonality, trends, etc. In various embodiments, if the data is highly non-linear, it may be determined that kernel-based methods/algorithms should be selected for training with the data.

According to various aspects of the present disclosure, determining one or more ML algorithms for model training can also include analyzing data volume and granularity. For example, the volume of data and the level of granularity required for training (e.g., at the SKU/location level vs. aggregated supply and demand) can influence algorithm selection. Furthermore, certain algorithms can be more computationally efficient and can therefore be selected for training with large and granular datasets.

Continuing with the discussion corresponding to step 210, the system can determine one or more ML algorithms for training based on algorithm properties such as accuracy, scalability, interpretability, etc. In one embodiment, the one or more ML algorithms for training can be determined/selected in response to evaluating algorithm accuracy in detecting true change points while minimizing false positives. In certain embodiments, scalability can be evaluated given certain algorithms are more capable of scaling to thousands of SKUs and locations due to computational efficiencies.

In a particular embodiment, certain algorithms can generate results that are generally more interpretable results than results from other algorithms. For example, Bayesian methods offer probabilistic interpretations that can improve decision-making by providing error bounds on outputs (e.g., improving the system's ability to detect a change in supply chain network data). In various embodiments, the system can determine that Bayesian methods/algorithms, such as Gaussian processes, are to be trained due to their probabilistic insights and characteristics.

In particular embodiments, Kernel-based methods can be selected for training where other algorithms may be unable to capture or detect non-linear patterns in a dataset. Further, and according to various aspects of the present disclosure, the system can implement both supervised and unsupervised training methods. In certain embodiments, such as where labelled examples of change point events may not be available, the system may implement unsupervised learning and training methods. In at least one embodiment, the system can receive and incorporate user or domain expert feedback (such as labelling a detected change point as significant or not) for performing supervised training methods.

According to various aspects of the present disclosure, the system can be configured to perform supervised machine learning training that leverages both multi-class classification and binary classification. In a particular embodiment, and in addition to the algorithms and models discussed herein, the system can be configured to leverage multi-class classification algorithms and models including (but not limited to) decision trees, nearest neighbor, support vector machine (SVM), Naïve Bayes, Bayesian Net, Hidden Markov Model (HMM), Conditional Random Field (CRF), Gaussian Mixture Model (GMM), and other similarly appropriate algorithms and models. In various embodiments, and in addition to the algorithms and models discussed herein, the system can be configured to leverage binary classification algorithms and models including (but not limited to) support vector machine (SVM), Naïve Bayes, logistic regression, and other similarly appropriate algorithms and models.

According to various aspects of the present disclosure, the system can be configured to perform unsupervised machine learning training and processing leveraging techniques such as (but not limited to) likelihood ratio methods, subspace models, probabilistic methods (such as Gaussian Processes), Kernel-based methods, clustering methods (sliding window—SWAB, k-means, minimum description length (MDL), shapelet transform, model fitting, etc.), graph-based methods, deep models, etc.

At step 212, and in various embodiments, the system is configured to train one or more machine learning models. According to various aspects of the present disclosure, training a machine learning model generally includes providing a machine learning algorithm with initial data (training data) from which the algorithm learns statistical relationships between aspects of the training data. According to various aspects of the present disclosure, the system is configured to train one or more selected machine learning algorithms, or the system can determine (based on characteristics identified within the received data or based on a desired outcome) an optimal machine learning algorithm for training. For example, time series analysis models/algorithms, regression models, artificial neural networks (ANNs), and the like, may be best suited for predicting inventory demand and supply fluctuations.

In various embodiments, training data can include historical data corresponding to inventory levels and sales transactions, and other supportive data such as data relating to promotions and expected seasonal demand, etc. In particular embodiments, the historical data and the supportive data can be received from the same or different supply chain network sources.

In certain embodiments, ML training at step 212 can include data preprocessing. In various embodiments, data preprocessing generally includes cleaning training data to remove any outliers and inconsistencies, handling missing values, normalizing data formats, ensuring data integrity, etc.

In at least one embodiment, ML training at step 212 can further include performing feature engineering. According to various aspects of the present disclosure, feature engineering includes identifying and constructing relevant features from raw data that can be used to train a machine learning model. As will be understood by one of ordinary skill in the art, features can be individual measurable properties or characteristics within a particular dataset. In certain embodiments, features might include (but are not limited to) historical sales trends, lead times, stock levels, and external factors such as market conditions or promotional events.

In various embodiments, training the ML model at step 212 can include splitting preprocessed data into multiple sets, such as a training set(s) and a validation set(s). As will be discussed in greater detail below in connection with step 214, the validation set(s) can be used for evaluating performance metrics associated with the machine learning model. Moreover, in particular embodiments, training the ML model at step 212 can include tuning hyperparameters, and iteratively improving model performance using techniques like cross-validation.

According to various aspects of the present disclosure, training a ML model for performing change point detection can include providing a particular machine learning algorithm with data such as sales transactions, inventory levels, supplier orders, lead times, deliveries, etc. In various embodiments, this training data may be historical data stored within the data warehouse 116. In a particular embodiment, the training data can be received from external sources, such as data input feeds from connected entities 104 and/or clients 106. In certain embodiments, the training data can be received at step 204, as discussed above.

In at least one embodiment, a training data set can include historical sales data, inventory levels, supply chain data, market factors, external factors, customer behavior data, operational data, and generally any other type of similar data. In various embodiments, historical sales data can include detailed records of sales transactions for each SKU/location, capturing the number of units sold, sales dates, and cost of items. In particular embodiments, historical sales data can include data that reflects seasonal patterns and trends over time, helping to distinguish normal seasonal variations from significant change points.

In one embodiment, data corresponding to inventory levels within the training data set can include current and historical inventory records for each SKU/location across time. In various embodiments, data corresponding to inventory levels within the training data set can also include data on when and how inventory is replenished or depleted, including restocking dates and quantities.

According to various aspects of the present disclosure, supply chain data can include lead times (information on the time taken for orders to be fulfilled by suppliers, from order placement to delivery), supplier performance (data on supplier reliability, including on-time delivery rates, order accuracy, and any other disruptions in supply chain), order and shipment records (logs of purchase orders, shipments, and receipt of goods, including quantities, dates and any discrepancies), etc.

In one example, market factors and external factors can include data on marketing and promotional activities, including discounts and sales events. In various embodiments, customer behavior data can include purchase frequency and patterns. In certain embodiments, operational data can include change logs recording any changes in business operations, such as changes in pricing, product offerings, inventory policies, etc.

In various embodiments, at step 214, the system can validate the one or more machine leaning models trained at step 212. According to various aspects of the present disclosure, validating the trained machine learning model includes evaluating the trained model on one or more separate validation datasets to assess or measure its accuracy, precision, and other relevant metrics. Moreover, in a particular embodiment, validating the model can include testing the model on real-world data to ensure it can produce generalizations and make accurate predictions based on the data.

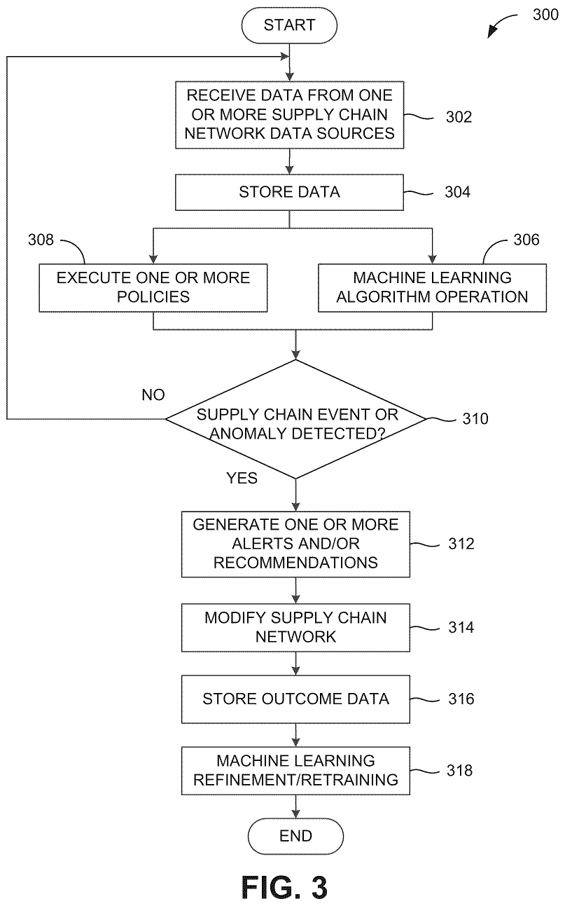

FIG. 3 is a flowchart of an example system operation process 300, according to one aspect of the present disclosure. In accordance with the discussion of the embodiments described throughout the present disclosure, the process 300 is generally the process by which the system receives supply chain data from a plurality of sources, parties, and data input feeds, and furthermore determines, based on the received supply chain data, whether a supply chain event, disturbance, or anomaly, has occurred, and the point in time at which it occurs. These aspects, and others, are discussed in greater detail below in connection with the description of FIG. 3.

In one embodiment, the example operation process 300 can begin at step 302, where the system receives data from one or more supply chain network data sources. As discussed above in connection with the description of FIGS. 1 and 2, the system (via the data input and output modules 114) can be configured to receive data from various supply chain entities 104 and client 106. In particular embodiments, data can be received from these sources (e.g., entities 104, clients 106, etc.) in real-time, such that data is fed or transmitted to the system on a continual basis as the data is generated and becomes available. In various embodiments, the system can also be configured to receive data from data sources on a batched basis, such that data is received intermittently, accordingly to a predetermined schedule or frequency, etc. According to various aspects of the present disclosure, the system can evaluate the most recently received data and can generate change point predictions on a certain frequency (e.g., once per week, twice per week, once per day, etc.). In certain embodiments, the system can configure its operation schedule based on how frequently the system is configured to report alerts to a user (an entity 104 or a client 106), or how frequently it is expected that a change or anomaly will occur. According to various aspects of the present disclosure, continuously receiving and ingesting real-time data from an inventory management system includes receiving ongoing sales, inventory updates, supplier deliveries, market trends, etc. Continuously receiving data can ensure the ML model is updated with the latest information

At step 304, in various embodiments, the system can be operatively configured to store the data received at step 302. In at least one example, the data is stored within the data warehouse 116 as introduced and discussed in connection with FIG. 1. In particular embodiments, the data received at step 302 can be stored in associated with the entity, client, or source from which it was received. In various embodiments, the data received at step 302 can be stored based on the data's characteristics or type, for example, whether the data relates to lead times, stock status, sales transactions, etc.

According to various aspects of the present disclosure, and generally in response to receiving and storing input data (steps 302 and 304, respectively), the system can be configured to perform the machine learning algorithm operation step 306 and/or the execute one or more policies step 308. In various embodiments, the system is configured to evaluate received data against one or more policies (such as stocking rules), as well as provide the received data to one or more machine learning algorithms or models. In particular embodiments, the steps 306 and 308 can be performed substantially simultaneously, in a particular order, or only one of the steps may be performed based on the data received.

In one embodiment, the machine learning algorithm operation step 306 generally includes providing the received and stored input data (from steps 302 and 304) to one or more trained machine learning models for determining whether a supply chain event or anomaly has occurred, as discussed in connection with the description of FIG. 2. In at least one example, the system can implement various methods and analyze various criteria, based on a particular employed algorithm, for determining whether a supply chain event or anomaly has occurred. For example, the system can analyze performance metrics such as precision and recall for determining whether an event or anomaly has occurred. In a particular embodiment, analyzing precision includes measuring a percentage of correctly identified change points out of all identified change points. In one embodiment, analyzing recall includes measuring a percentage of actual change points that were correctly identified. According to various aspects of the present disclosure, high precision and recall (for example, greater than 90%, 91%, 92%, 93%, 94%, 95%, or higher) indicates accurate detection. In particular embodiments, analyzing precision and/or recall may include leveraging a labelled dataset, or the system can leverage feedback data generated through user interaction.

The system can use confidence scores for determining whether a change or anomaly has been detected. In one embodiment, change point algorithms can assign confidence scores (or thresholds) to detected change points. In particular embodiments, the system can use predetermined thresholds over which detected change points can be considered accurate (and thus representative of a detected anomaly). For example, a predetermined confidence threshold can be established at 85% or higher, or at any appropriate percentage, such that a detected change point is indicated as accurate if the confidence threshold is met or exceeded. The system can also be configured with lower confidence thresholds, such as a threshold value within the range of 60% to about 85%, where the system can indicate that a detected event with a corresponding confidence score in this threshold range may represent a potential change point and should be evaluated further. In various embodiments, the system can use statistical significance for determining whether a change or anomaly has been detected. In certain embodiments, and for certain algorithms, statistical tests can be used to determine the significance of detected changes. For example, statistical testing can be used for determining which model (of two or more models) is more likely to accurately detect a change (for example, comparing a model with a changed mean to a model with an unchanged mean). In at least one example, a p value of less than 0.05 can indicate whether a detected change is statistically significant.

The system can use validation and cross-validation techniques for determining whether a change or anomaly has been detected. For example, for models trained on labelled training data and validated on a testing set, input data can be compared to known outcomes and relationships based on the labelled training data.

The system can use Bayesian change point detection for determining whether a change or anomaly has occurred. For example, the system can evaluate the posterior probabilities of change points. In one embodiment, higher probabilities (e.g., 85% 90%, 95%, etc.) indicate a greater likelihood that a change has occurred at a particular point. However, these predetermined probabilities can be configured to any appropriate threshold level. In various embodiments, a threshold can be set to filter out low-probability detections. According to various aspects of the present disclosure, the system can also analyze a Bayes factor, which can include comparing models with and without change points to ensure that detected changes significantly improve model fit. In a particular embodiment, analyzing Bayes factors can include comparing multiple models to determine a particular model that is most representative of the observed data.

The system can use kernel-based methods for determining whether a change or anomaly has occurred. For example, the system can analyze shifts in kernel density estimates, and significant deviations from a baseline density can indicate a change point (occurrence of a supply chain change or anomaly). In at least one embodiment, the system can be configured to determine if a kernel-based model implemented prior to a potential change point still appropriately fits the data in response to detecting a change point.

At step 308, in one embodiment, the system can execute one or more policies against the data received at step 302. According to various aspects of the present disclosure, executing one or more policies can include performing supply chain data determinations, such as analyzing whether any SKU and/or supplier performances changes are represented in the received data. In one embodiment, analyzing SKU and/or supplier performances changes can include identifying items where a prior month's demand is greater than a certain percentage (such as 150%) of the next highest demand month over a certain period of time. Executing one or more policies can also include identifying SKUs where a recent significant (5%, 10%, 15%, 25%, 50%, 100%, etc.) increase in a number of distinct customers is detected. In various embodiments, executing one or more policies can include calculating recent demand changes for top customers. In various embodiments, calculating recent demand changes for top customers can include identifying items where the top customer makes up greater than X % (for example, 50%) of the total sales transaction, calculating the average, standard deviation, maximum, and most recent lag between invoices, and identifying items where the last invoice is older than the average lag plus a predetermined number of standard deviations.

Proceeding to step 310, the system can determine whether a supply chain event or anomaly has been detected, either in the processing of step 306, step 308, or both. In various embodiments, a supply chain event or anomaly may have been detected or identified as a result of step 308 if, for example, one or more policies or rules were triggered based on data received at step 302. In at least one embodiment, a supply chain event or anomaly may have been detected as a result of step 306 if, for example, a trained machine learning model detected a change point in light of processing the data received at step 302. If the system determines that no anomaly, change, or event is detected within the supply chain network data processed at step 306 and/or step 308, the process 300 can return to step 302 to continue to receive data from the one or more supply chain network data sources/nodes. In one embodiment, if the system determines that an anomaly, change, or event is in fact detected within the supply chain network data processed at step 306 and/or step 308, the process 300 can proceed to step 312.

In one embodiment, at step 312 the system can generate one or more alerts, recommendations, predictions, etc., based on the event or anomaly detected in the supply chain network data. In a particular embodiment, a generated alert can be transmitted to an entity 104, a client 106, or any other system user, via email, text/SMS message, via a message or notification in an inventory management dashboard (for example, which may be a GUI or the like at an entity 104 or client 106 and can allow for the entity or client to control/access the event detection system 102). In at least one embodiment, the generated alert can include insights, such as detailed reports and visualizations that offer insights into the detected changes, including potential causes and recommended actions.

In particular embodiments, the system, at step 314, can be configured to modify the supply chain network. In at least one embodiment, the system can be configured to automatically modify the supply chain network in response to the system detecting or identifying one or more anomalies in a supply chain network. According to various aspects of the present disclosure, modifying the supply chain network can include adjusting order volumes for a particular SKU in light of detecting, for example, an excess in inventory for that particular SKU, a decrease in demand for that particular SKU, and/or other event such as the completion of a third-party project for which the particular SKU was stocked, etc.

In at least one embodiment, modifying the supply chain network can also include reconfiguring connections between the supply chain network nodes (the computing devices comprising the supply chain network) in order to mitigate adverse effects of the detected change or anomaly, or to improve the efficiency of the supply chain network as a whole by reducing delays, down time, etc. For example, in response to detecting one or more discrete events in supply chain network data that are indicative of anomalous or incongruous behavior in the network, the system can be configured to determine which node or data source in the supply chain network is causing the identified behavior. In one embodiment, the system can execute a traceroute, or a similar tracing operation, for identifying the one or more network nodes or sources causing the identified behavior. In one embodiment, the system can be configured to disconnect from, route around, reroute from, “drop,” or “block” a supply chain network node or source causing the identified behavior, or otherwise adjust the network's reliance upon the supply chain network node or source causing the identified behavior. According to various aspects of the present disclosure, the system can be configured to isolate the supply chain network node or source causing the identified behavior for a predetermined amount of time (1 day, 7 days, 14 days, 30 days, etc.), until the node is no longer exhibiting anomalous behavior, etc., or the node can be disconnected from the supply chain network. In at least one embodiment, isolating a problematic supply chain network node can include replacing the supply and/or demand corresponding to that particular node with supply and/or demand from one or more separate replacement supply chain nodes or sources such that the entirety of the supply chain network can continue to operate without the risk of harmful effects resulting from the problematic node.

At step 316, the system can be configured to store data corresponding to one or more outcomes in connection with the alerts and/or recommendations generated at step 312, or in connection with the supply chain network modifications from step 314, or other changes to the system or supply chain. In a particular embodiment, this data can be stored at within the data warehouse 116. In one embodiment, the system continuously ingests new data (which can be used to improve models), and the system receives user feedback data in response to generated alerts, which can all be stored within the data warehouse 116.

At step 318, and according to various aspects of the present disclosure, the system can refine and/or retain the machine learning algorithms and models. In various embodiments, refining and/or retraining the machine learning algorithms and models continuously improves the system and ensures the system remains adaptive and effective in a dynamic environment. In one embodiment, user engagement data provides unique training data that can be used to improve the system by improving the ability of the system to classify change point events as significant or not. In particular embodiments, outcomes from the model's predictions and/or the actions taken in response thereto (such as those stored at step 316) can be fed back into the system as new inputs for continuously improving its accuracy and reliability. In various embodiments, the system can periodically retrain the model with new data to ensure it adapts to changing market conditions and maintains high performance.

### CONCLUSION

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can include various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions include, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represents examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program engines may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program engines, and other data for the computer.

Computer program code that implements the functionality described herein typically includes one or more program engines that may be stored on a data storage device. This program code, as is known to those skilled in the art, usually includes an operating system, one or more application programs, other program engines, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program engines depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed technology will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the technology to the precise forms disclosed. Many modifications and variations are possible in light of the above teaching.

The embodiments were chosen and described in order to explain the principles of the technology and their practical application so as to enable others skilled in the art to utilize the technology and various embodiments and with various modifications as are suited to the particular use contemplated. Alternative embodiments will become apparent to those skilled in the art to which the technology pertains without departing from their spirit and scope. Accordingly, the scope of the present technology will ultimately be defined by the claims in any resulting issued patent rather than the foregoing description and the exemplary embodiments described therein.

What is claimed is:

1. A method, comprising:
training, by one or more processors, a machine learning model based on historical enterprise resource planning (ERP) input data associated with a time series dataset and a corresponding training algorithm, wherein the historical ERP input data corresponds to one or more entities and one or more clients in a supply chain network;
receiving additional input data from the one or more entities and/or from the one or more clients, wherein the additional input data represents real-time data from the supply chain network;
detecting one or more discrete events in the additional input data, wherein the one or more discrete events are indicative of anomalous behavior in the supply chain network;
determining one or more source nodes of the one or more discrete events indicative of anomalous behavior in the supply chain network, wherein the one or more source nodes comprise at least one entity or at least one client; and
initiating one or more remediation actions based on the anomalous behavior detected from the one or more source nodes, wherein initiating the one or more remediation actions comprises generating a modification to one or more inventory management configurations at the one or more entities and/or the one or more clients to adjust for the anomalous behavior detected from the one or more source nodes.

2. The method of claim 1, wherein the corresponding training algorithm comprises a change point detection algorithm.

3. The method of claim 2, wherein the change point detection algorithm comprises Bayesian change point criteria for detecting one or more discrete events in the additional input data, and wherein the Bayesian change point criteria comprise a predetermined posterior probability threshold and/or a Bayes factor.

4. The method of claim 2, wherein the change point detection algorithm comprises kernel-based change point criteria for detecting one or more discrete events in the additional input data, and wherein the kernel-based change point criteria comprise kernel density estimates and shifts.

5. The method of claim 1, wherein prior to training the machine learning model, the method further comprises generating one or more features based on the historical ERP input data, wherein the one or more features comprise measurable characteristics corresponding to identified patterns in the historical ERP input data.

6. The method of claim 1, wherein initiating the one or more remediation actions further comprises overriding the one or more inventory management configurations at the one or more entities and/or the one or more clients to adjust for the anomalous behavior detected from the one or more source nodes.

7. The method of claim 1, wherein the historical ERP input data and the additional input data comprise multivariate data received from the one or more entities and the one or more clients in the supply chain network.

8. A system, comprising:
a processor; and
a memory on which are stored machine-readable instruction that when executed by the processor, cause the processor to:
train a machine learning model based on historical enterprise resource planning (ERP) input data associated with a time series dataset and a corresponding training algorithm, wherein the historical ERP input data corresponds to one or more entities and one or more clients in a supply chain network;
receive additional input data from the one or more entities and/or from the one or more clients, wherein the additional input data represents real-time data from the supply chain network;
detect one or more discrete events in the additional input data, wherein the one or more discrete events are indicative of anomalous behavior in the supply chain network;
determine one or more source nodes of the one or more discrete events indicative of anomalous behavior in the supply chain network, wherein the one or more source nodes comprise at least one entity or at least one client; and
initiate one or more remediation actions based on the anomalous behavior detected from the one or more source nodes, wherein initiating the one or more remediation actions comprises generating a modification to one or more inventory management configurations at the one or more entities and/or the one or more clients to adjust for the anomalous behavior detected from the one or more source nodes.

9. The system of claim 8, wherein the corresponding training algorithm comprises a change point detection algorithm.

10. The system of claim 9, wherein the change point detection algorithm comprises Bayesian change point criteria for detecting one or more discrete events in the additional input data, and wherein the Bayesian change point criteria comprise a predetermined posterior probability threshold and/or a Bayes factor.

11. The system of claim 9, wherein the change point detection algorithm comprises kernel-based change point criteria for detecting one or more discrete events in the additional input data, and wherein the kernel-based change point criteria comprise kernel density estimates and shifts.

12. The system of claim 8, wherein prior to training the machine learning model, the processor is further caused to generate one or more features based on the historical ERP input data, wherein the one or more features comprise measurable characteristics corresponding to identified patterns in the historical ERP input data.

13. The system of claim 8, wherein initiating the one or more remediation actions further comprises overriding the one or more inventory management configurations at the one or more entities and/or the one or more clients to adjust for the anomalous behavior detected from the one or more source nodes.

14. The system of claim 8, wherein the historical ERP input data and the additional input data comprise multivariate data received from the one or more entities and the one or more clients in the supply chain network.

15. A non-transitory computer readable medium comprising instructions, that when read by a processor, cause the processor to perform:
training, by one or more processors, a machine learning model based on historical enterprise resource planning (ERP) input data associated with a time series dataset and a corresponding change point detection training algorithm, wherein the historical ERP input data corresponds to one or more entities and one or more clients in a supply chain network;
receiving additional input data from the one or more entities and/or from the one or more clients, wherein the additional input data represents real-time data from the supply chain network;
detecting one or more discrete events in the additional input data, wherein the one or more discrete events are indicative of anomalous behavior in the supply chain network;
determining one or more source nodes of the one or more discrete events indicative of anomalous behavior in the supply chain network, wherein the one or more source nodes comprise at least one entity or at least one client; and
initiating one or more remediation actions based on the anomalous behavior detected from the one or more source nodes, wherein initiating the one or more remediation actions comprises generating a modification to one or more inventory management configurations at the one or more entities and/or the one or more clients to adjust for the anomalous behavior detected from the one or more source nodes.

16. The non-transitory computer readable medium of claim 15, wherein the change point detection algorithm comprises Bayesian change point criteria for detecting one or more discrete events in the additional input data, and wherein the Bayesian change point criteria comprise a predetermined posterior probability threshold and/or a Bayes factor.

17. The non-transitory computer readable medium of claim 15, wherein the change point detection algorithm comprises kernel-based change point criteria for detecting one or more discrete events in the additional input data, and wherein the kernel-based change point criteria comprise kernel density estimates and shifts.

18. The non-transitory computer readable medium of claim 15, wherein prior to training the machine learning model, the processor is further caused to perform generating one or more features based on the historical ERP input data, wherein the one or more features comprise measurable characteristics corresponding to identified patterns in the historical ERP input data.

19. The non-transitory computer readable medium of claim 15, wherein initiating the one or more remediation actions further comprises overriding the one or more inventory management configurations at the one or more entities and/or the one or more clients to adjust for the anomalous behavior detected from the one or more source nodes.

20. The non-transitory computer readable medium of claim 15, wherein the historical ERP input data and the additional input data comprise multivariate data received from the one or more entities and the one or more clients in the supply chain network.
